(19) United States
(12) Patent Application Publication
(10) Pub. No.: US 2009/0100866 A1
(43) Pub. Date: Apr. 23, 2009

(54) Jewelry for Infant Teething

(76) Inventor: Amy Maurer Creel, Ashton, MD (US)

Correspondence Address: The Marbury Law Group, PLLC, 11800 SUNRISE VALLEY DRIVE, SUITE 1000, RESTON, VA, 20191, US

(21) Appl. No.: 12/253,366

(22) Filed: Oct. 17, 2008

Related U.S. Application Data
(60) Provisional application No. 60/980,578, filed on Oct. 17, 2007.

(51) Int. Cl. A44C 13/00; A44C 5/00; A44C 25/00; A61J 17/02

(52) U.S. Cl. 63/1.11; 63/3.1; 63/23; 606/235; 63/3

(57) ABSTRACT

Jewelry in the form of necklaces, bracelets, and bangles has a prominent component that is smooth and has a shape that is round or has rounded edges with no sharp edges or points. The jewelry is ornamentally attractive and is useful when worn on the person of a caregiver so that an infant can teeth on the jewelry. The jewelry is nontoxic and dishwasher safe.

### RELATED APPLICATIONS

This application claims the benefit of U.S. Provisional Application Ser. No. 60/980,578, filed Oct. 17, 2007, which is hereby incorporated by reference.

### FIELD OF THE INVENTION

This invention relates to jewelry. More specifically, the invention relates to jewelry that functions to ease teething pain of an infant.

### BACKGROUND INFORMATION

Babies go through teething phases as their teeth grow. Frequently, when a baby is being carried by his mother, the infant will reach for any jewelry in sight (e.g., a necklace) and place it in his mouth.

This is not satisfactory because jewelry articles, which tend to have many crevices are unlikely to be sanitary. Further, sharp edges of a necklace, bracelet, or baubles attached thereto could damage young gums and cause infection.

### SUMMARY OF THE INVENTION

Jewelry according to the various embodiments takes the form of necklaces, bracelets, and bangles. Embodiments of the invention include at least one prominent component that is smooth and has a shape that is round or has rounded edges with no sharp edges or points.

Jewelry according to the various embodiments is ornamentally attractive and is useful when worn on the person of a caregiver so that an infant can teeth on the jewelry.

Jewelry according to the various embodiments is formed of materials that are non-porous and are dishwasher safe. This enables the jewelry to be sanitized and washed with ease.

According to some embodiments, the jewelry is made of hard plastic polymer in smooth and rounded shapes and is sized to be worn as a necklace.

### BRIEF SUMMARY OF THE DRAWINGS

FIG. 1A illustrates a necklace according to a first embodiment.

FIG. 1B illustrates an embodiment of a necklace and its breakaway clasp.

FIG. 2 illustrates a necklace according to a variant of the first embodiment.

FIG. 3 illustrates a bangle according to another embodiment.

FIG. 4 illustrates a keychain according to yet another embodiment.

### DETAILED DESCRIPTION

By its nature, jewelry is ornamental. In some instances, jewelry also has a functional aspect. As described in below, jewelry is embodied that is functional for use by a teething infant to relieve teething pain by biting down on the jewelry without posing undue risk of infection due to unhygienic state of the jewelry.

Jewelry according to the various embodiments in accordance with the present invention is free to take any form that would be within easy reach of an infant being held by a caregiver. Examples of suitable jewelry types are necklaces, bracelets, and bangles. This listing of examples is not intended to limit the scope of the invention, which may be embodied as other types of jewelry.

The embodiments include at least one prominent component that is smooth and has a shape that is round or has rounded edges with no sharp edges or dangerous points. This component which is intended to be chewed on by teething infants is sufficiently large so as not to pose a choking hazard to the child. One way to ensure choking safety is to make the teething component no less than approximately 1.75 inches or 44.45 mm in diameter. Another way to ensure choking safety is to make the teething component sufficiently large as to not fit inside a choke test cylinder, which has an interior diameter of 1.25 inches or 31.75 mm and a slanted bottom with a depth ranging from 1 to 2.25 inches or 25.4 to 57.15 mm. Other standards may be substituted for these as toy safety engineering advances in the future.

Jewelry according to the various embodiments of the present invention is formed of materials that are non-porous and are dishwasher safe. This enables the jewelry to be sanitized and washed with ease.

Jewelry according to the various embodiments is made of hard plastic polymer in smooth and rounded shapes. Examples of suitable food grade polymer materials are silicone, polycarbonate, polyester and polyethylene. High density polyethylene (HDPE) is a commonly available food grade plastic that is useful for embodying the invention. These materials are not only safe for use to form teething implements, they can be molded as jewelry components in a variety of aesthetically pleasing shapes and fashionable colors. The materials listed are but examples, and the invention may be embodied by any materials having properties that make it amenable to safe teething and to adaptation for jewelry aesthetics.

It is important that the jewelry components be non toxic. In particular, any material chosen to embody the invention should be lead free and phthalate free.

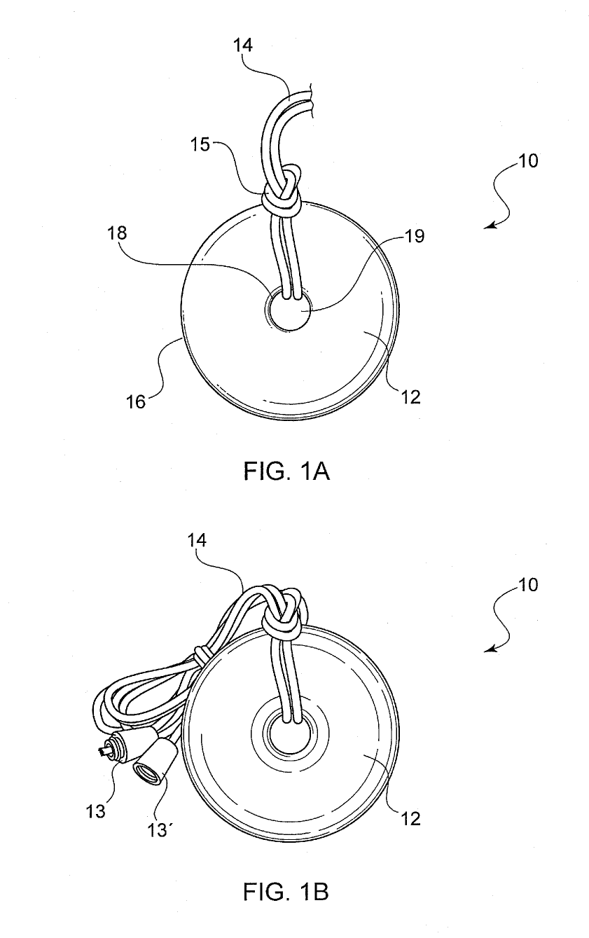

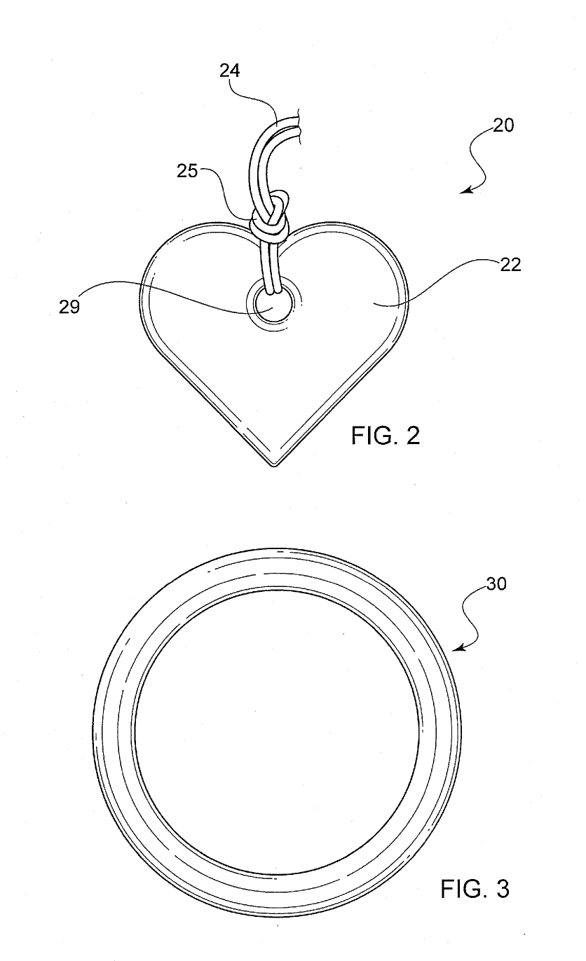

Referring to FIG. 1A, a necklace 10 according to a first embodiment is illustrated. A pendant 12 hangs from a necklace cord 14 that is sized to fit comfortably over a wearer's head and hang from the shoulders around the wearer's neck. The pendant 12 has a flatted toroidal shape and acts as a teething component for the necklace 10. The pendant 12 is polished to a smooth finish and has its edges 16, 18 rounded. The toroidal shape pendant 12 has sufficient major dimensions to prevent choking, but is preferably not so large as to detract from wearing as jewelry. Major dimensions of approximately 2 inches×2 inches or approximately 50 mm×50 mm have been found useful.

The pendant 12 in the illustrated embodiment is affixed to the necklace cord 14 via a knot 15 in the necklace cord 14 tied through the center hole 19 of the pendant 12. An advantage of the knot 15 is that it is simple and secure. The knotted attachment can allow use with variously colored necklace cords and can allow detachment of the pendant 12 so that the pendant 12 can be washed in a dishwasher and the necklace cord 14 washed in a clothes washer. Alternatively, the pendant 12 may be connected to the necklace 10 using suitable jewelry fittings.

The toroidal teething component of pendant 12 is illustrated with the hole 19 being in the center. However, the hole placement is not critical and the hole can be offset from center of the teething component.

Referring to FIG. 1B, a necklace 10 according to a variant of the first embodiment includes a necklace cord 14 with a breakaway clasp 13, 13′. The breakaway clasp 13, 13′ can take any suitable form that will hold the necklace 10 in ordinary use to the wearer, but which will release to prevent a choking hazard to the wearer or child, typically at approximately between 5 and 10 pounds of force, depending on the applicable safety standards. The breakaway clasp 13, 13′ can include, but is not limited to, plastic snap fit clasps (illustrated), magnetic clasps, ordinary jewelry clasps with frangible or releasable elements, and hook-and-loop closures. The necklace cord 14 is preferably of a type used for jewelry, such as, but not limited to, silk cord, woven silk cord, ribbon, leather cord, pleather cord, macrame, waxed cotton, and waxed linen. If a jewelry fitting is used to attach the necklace cord 14 to the pendant 12, metal necklace chains can also be used.

Although illustrated with respect to an embodiment, a breakaway clasp 13, 13′ is a useful optional feature for any necklace embodiment.

Referring to FIG. 2, a necklace 20 according to a variant of the first embodiment of the invention is illustrated. A pendant 22 hangs from a necklace cord 24 that is sized to fit comfortably over a wearer's head and hang from the shoulders around the wearer's neck. The pendant 22 has a flatted “heart” shape and acts as a teething component for the necklace 20. The pendant 22 is polished to a smooth finish and has its edges rounded.

The pendant 22 is affixed to the necklace cord 24 via a knot 25 in the necklace tied through a hole 29 formed in the pendant 22. The heart shaped teething component is illustrated with the hole 29 being placed symmetrically along a longitudinal axis of the pendant 22. However, the hole placement is not critical and the hole 29 can be offset from the longitudinal axis of the pendant 22.

Referring to FIG. 3, a bangle 30 according to a second embodiment of the invention is illustrated. While multiple bangles can be worn simultaneously, each such bangle 30 takes the form of a thin toroid with an ovoid cross-section. The inner diameter of the bangle 30 is selected to slide over a wearer's hand and rest about the wrist. The entire bangle 30 functions as a teething component and has a smooth surface. Ovoid cross-sections usable with this embodiment include, but are not limited to, generally circular, oval, and egg-shaped cross sections, and smoothly-blended combinations thereof.

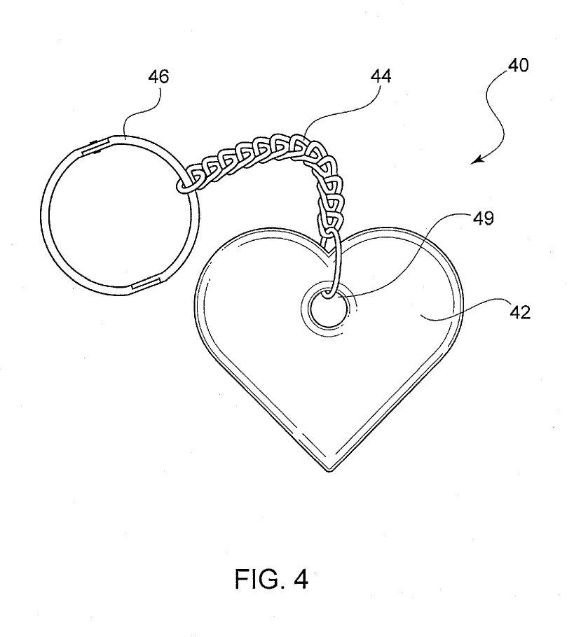

Referring to FIG. 4, a keychain 40 according to a third embodiment of the invention is illustrated. A ring 46 for retaining keys or other objects is fastened via short chain 44 to a teething component 42. In the illustrated case, the teething component 42 is “heart” shaped. The teething component 42 is sized to prevent choking, polished to a smooth finish, and has its edges rounded.

The heart shaped teething component 42 is illustrated with the hole 49 being placed symmetrically along its longitudinal axis. However, the hole placement is not critical and the hole 49 can be offset from the longitudinal axis.

Teething components according to the various embodiments are made of hard plastic polymer in smooth and rounded shapes. Examples of suitable food grade polymer materials are polycarbonate, polyester, polyethylene and medical grade silicone. High density polyethylene (HDPE) is a commonly available food grade plastic that is useful for embodying the invention. These materials are not only safe for use to form teething implements, they can be molded as jewelry components in a variety of aesthetically pleasing shapes and fashionable colors. The materials listed are but examples, and the invention may be embodied by any similar materials having properties that make it amenable to safe teething and to adaptation for jewelry aesthetics.

Aesthetically pleasing teething components can be formed to simulate jewelry and gemstones, including, but not limited to, onyx, jade, garnet, amethyst, emerald, amber, coral, opal, quartz, rose quartz, malachite, tourmaline, lapis, moonstone, mother of pearl, shell, turquoise, gold, silver, bronze, copper, hematite, and ornamental wood. The teething components can also be formed in various fashion colors as well as patterns, and may have various levels of sheen, from matte to glossy.

Ways for providing teething-safe jewelry have been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

What is claimed is:

1. A jewelry article for use in teething, the article comprising:
a teething component, the teething component having an aesthetic appearance of jewelry and consisting essentially of:
a hard, food grade plastic material that is lead free and phthalate free;
a smooth nonporous surface;
rounded edges; and
dimensions sized to resist choking.

2. The jewelry article of claim 1, wherein the material is a dishwasher-safe material selected from the group consisting of silicone, polycarbonate, polyester, polyethylene, and high density polyethylene.

3. The jewelry article of claim 1, wherein the teething component consists of a pendant.

4. The jewelry article of claim 3, wherein the pendant is formed in the shape of a flattened toroid.

5. The jewelry article of claim 3, wherein the pendant is formed in the shape of a flattened heart shaped member.

6. The jewelry article of claim 3, further comprising:
a hole in the pendant;
a necklace cord secured to the pendant with a knot; and
a breakaway clasp on the necklace cord.

7. The jewelry article of claim 6, wherein the necklace cord is a silk cord.

8. The jewelry article of claim 1, wherein the teething component dimensions sized to resist choking are sufficiently large as to not fit inside a choke test cylinder having an interior diameter of 31.75 mm and a slanted bottom with a depth ranging from 25.4 mm to 57.15 mm.

9. The jewelry article of claim 8, wherein major dimensions of the teething component are approximately 50 mm×50 mm.

10. The jewelry article of claim 1, wherein the aesthetic appearance of jewelry simulates the appearance of material selected from the group consisting of onyx, jade, garnet, amethyst, emerald, amber, coral, opal, quartz, rose quartz, malachite, tourmaline, lapis, moonstone, mother of pearl, shell, turquoise, gold, silver, bronze, copper, hematite, and ornamental wood.

11. The jewelry article of claim 1, wherein the material consists of medical grade silicone.

12. The jewelry article of claim 1, wherein the teething component consists essentially of a bangle formed in the shape of a thin toroid with an ovoid cross-section, the bangle having an inner diameter sized to slide over a wearer's hand and rest about the wearer's wrist.

13. The jewelry article of claim 12, wherein the material is a dishwasher-safe material selected from the group consisting of polycarbonate, polyester, polyethylene, and high density polyethylene.

14. The jewelry article of claim 12, wherein the ovoid cross-section is selected from the group consisting of a circle, an oval, and an egg-shape.

15. The jewelry article of claim 6, wherein the pendant is formed in the shape of a flattened toroid and wherein the material is a dishwasher-safe material selected from the group consisting of polycarbonate, polyester, polyethylene, and high density polyethylene.

16. The jewelry article of claim 15, wherein major dimensions of the flattened toroid are approximately 50 mm×50 mm; and
wherein the aesthetic appearance of the flattened toroid simulates jewelry selected from the group consisting of onyx, jade, garnet, amethyst, emerald, amber, coral, opal, quartz, rose quartz, malachite, tourmaline, lapis, moonstone, mother of pearl, shell, turquoise, gold, silver, bronze, copper, hematite, and ornamental wood.

17. The jewelry article of claim 6, wherein the pendant is formed in the shape of a flattened heart shaped member and wherein the material is a dishwasher-safe material selected from the group consisting of polycarbonate, polyester, polyethylene, and high density polyethylene.

18. The jewelry article of claim 17, wherein major dimensions of the flattened heart are approximately 50 mm×50 mm; and
wherein the aesthetic appearance of the flattened heart simulates jewelry selected from the group consisting of onyx, jade, garnet, amethyst, emerald, amber, coral, opal, quartz, rose quartz, malachite, tourmaline, lapis, moonstone, mother of pearl, shell, turquoise, gold, silver, bronze, copper, hematite, and ornamental wood.

19. A jewelry set for use in teething, the jewelry set consisting essentially of:
a pendant teething component, the pendant teething component having an aesthetic appearance of jewelry and consisting essentially of:
a hard, food grade plastic material that is lead free, phthalate free, and selected from the group consisting of polycarbonate, polyester, polyethylene, and high density polyethylene;
a smooth nonporous surface;
rounded edges;
a hole; and
major dimensions of approximately 50 mm×50 mm to resist choking;
a necklace cord secured to the pendant through the hole with a knot;
a breakaway clasp on the necklace cord;
a bangle teething component, the bangle teething component having an aesthetic appearance of jewelry complimentary to the pendant teething component and consisting essentially of:
a hard, food grade plastic material that is lead free, phthalate free, and selected from the group consisting of polycarbonate, polyester, polyethylene, and high density polyethylene;
a smooth nonporous surface;
rounded edges; and
a shape of a thin toroid with an ovoid cross-section, the shape having an inner diameter sized to slide over a wearer's hand and rest about the wearer's wrist.

20. The jewelry set of claim 19, wherein the aesthetic appearance of both the pendant teething component and the bangle teething component simulates jewelry selected from the group consisting of onyx, jade, garnet, amethyst, emerald, amber, coral, opal, quartz, rose quartz, malachite, tourmaline, lapis, moonstone, mother of pearl, shell, turquoise, gold, silver, bronze, copper, hematite, and ornamental wood.
